(19) United States
(12) Patent Application Publication
(10) Pub. No.: US 2013/0254806 A1
(43) Pub. Date: Sep. 26, 2013

(54) System and Method for Displaying a Media Program Stream on Mobile Devices

(71) Applicant: STATION CREATOR, LLC, New York, NY (US)

(72) Inventors: Sheehan Alam, Phoenix, AZ (US); John Labes, San Diego, CA (US); Tom Peterson, Phoenix, AZ (US)

(73) Assignee: STATION CREATOR, LLC, New York, NY (US)

(21) Appl. No.: 13/783,638

(22) Filed: Mar. 4, 2013

Related U.S. Application Data
(63) Continuation-in-part of application No. 13/425,169, filed on Mar. 20, 2012.

(51) Int. Cl. H04N 21/482

(52) U.S. Cl. CPC H04N 21/482
USPC 725/38

(57) ABSTRACT

A system and method of displaying a sequence of media clips using a application program operating on a user's computer that natively displays web content such that each media clip is automatically displayed after the previous clip is completed, where the sequence is controlled and determined at a remote location from the user's computer and the display of the sequence on the user's computer occurs without any ongoing interaction with the application.

This application is a Continuation in Part of U.S. patent application Ser. No. 13/425,169 filed on Mar. 30, 2012 and incorporates that application herein by reference for all that it teaches.

### BACKGROUND OF THE INVENTION

One application of communication among a set of computers connected to the Internet or other network is that computer users browsing the Internet can ferret out a list of hyperlinks to media clips, for example, that is, video or audio or audio visual content to access or view. The user can select these clips by actuating a hyperlink displayed on their computer screen by Internet browser software running on their computer and then view the video or listen to the clip. However, this approach requires the viewer to actively search for media clips and to select each of the selected media clips at the time they want to view them. In some cases, a website has audio-visual content its operators would like to present visitors to the website, but typically have no way to easily assemble all of the content necessary to create an Internet delivered program stream that does not require interactivity. In addition, website operators that would like to have an Internet delivered program stream must typically curate the selected items, and then try and assemble the media clips into one long media data file. This process is both labor intensive and further requires the website to host the compilation of media clips, which may require special licenses from many copyright owners.

Therefore, there is a need for an improved system and method of selecting and specifying digital media clips in order to specify and deliver to a user's computer an automated sequence of media clips that represent a custom built program stream. There is a need for an authoring tool that permits a program stream author to create a list of available media clips, create a playback list, and an engine that causes each of the listed media clips to be transmitted at the appropriate time from their respective hosted locations to a user's browser operating on the user's computer. In one embodiment, the system automatically schedules each media clip delivery so that as soon as one clip ends, the next one begins. In this way, the user visiting a website that utilizes the invention sees or hears an ongoing program stream that has a sequence of pre-selected sources without having to individually select and actuate each element.

The invention entails receiving a link to a media clip, determining the length of time to play the media clip and storing in a data record the metadata associated with the media clip referenced by the link. The invention further entails automatically determining a start time from a known stop time and run time, or a stop time from a known start time and run time. The invention entails compiling a list of media clip hyperlinks and their associated start times and then causing a sequence of transmissions of the video and audio data of each media clip to a specific receiving location where the sequence is the order of the media clip references in the list and the start time for each media clip is that indicated in the list. The invention further entails setting up a communications channel for each program stream with the browsers that are accessing the program stream and then transmitting the media references in sequence through the channel. The invention further entails receiving the media references at the user's browser, and having the browser modify its webpage data using the media reference data and then redisplay the webpage in order to cause the referenced media to be accessed and rendered by the browser.

### BRIEF DESCRIPTION OF THE DRAWINGS

FIG. 1: Depicts the architecture of the system.

FIG. 2: Flowchart for server side of system.

FIG. 3: Flowchart for user side of system.

FIG. 4: Architecture of multiple pollers and multiple schedulers.

FIG. 5: Screenshot for playlist authoring functionality.

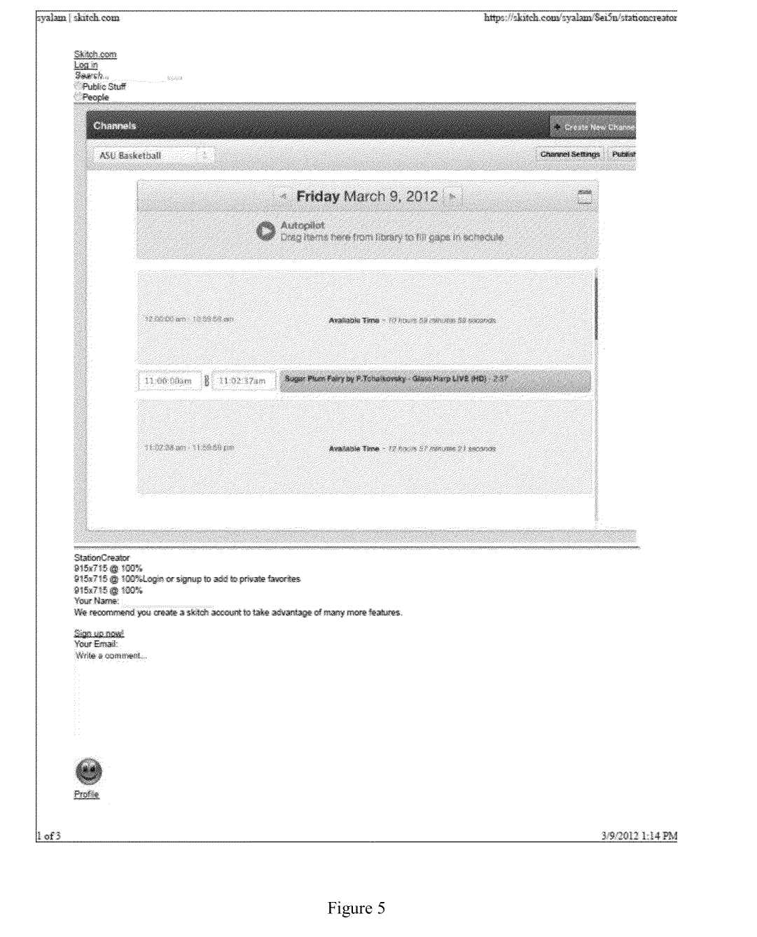

FIG. 6: Screenshot of click and drag prompt for playlist authoring.

FIG. 7: Flowchart for native rendering embodiment.

### DETAILED DESCRIPTION OF THE PREFERRED EMBODIMENT

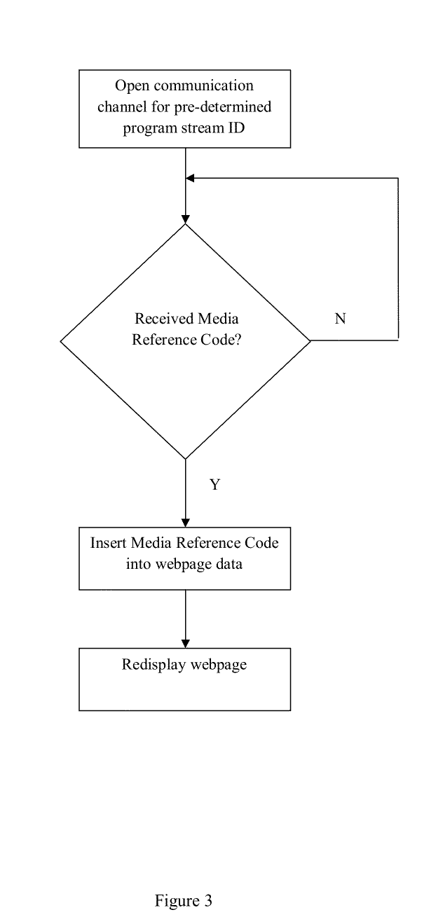

A user operating a computer adapted to embody the invention will visit an Internet website that transmits a webpage to the user's browser operating on their computer. The browser operates by receiving a script file from the website that contains instructions. When the script file code is executed, it causes the browser to transmit further requests for information in accordance with these code instructions. In one embodiment of the invention, a webpage may contain code that references another website that has a media clip available for transmission. This webpage can be dynamically altered using the scripts operated by a user's browser program that is rendering the webpage. The alteration can be a revision to the code that references the media clip in order that the reference be made to a new media clip. When the browser re-displays the webpage with the alteration, the rendering of the new media clip is commenced. In order to have this occur automatically, the user's browser is instructed by means of a script that opens a communication channel with a remote location. The data received over that channel includes the reference to the new media clip. As depicted in FIG. 3, the browser waits on the condition of receiving a new media reference code, and in that event, alters the webpage itself and then triggers the re-display to commence rendering of the newly referenced media clip. The invention exploits this capability to create an ongoing program experience for the user.

The media clip is essentially a digital data file that, when rendered, causes the display of video programming, audio programming or a combination or even one or more still images. In this manner, the display of the first website's webpage causes a media clip hosted on another website to be displayed in the user's browser. The media clip data stream can be in any kind of codec or format, for example, MPEG, Flash Video, so long as the browser has the capability of rendering the data into actual pixels displayed on the user's computer screen or sound emanating from its loudspeaker.

In one embodiment of the invention, the system collects metadata regarding a pre-selected set of media clips. The metadata can include the video, audio or audiovisual title, descriptive text, start time, end time and duration. Where the duration is not listed, the duration can be calculated. The metadata can also include the media reference code associated with the media clip. In one embodiment, the media reference code is a combination of a URL and an alphanumeric string that uniquely identifies a media data file located at the directory referenced by URL. The system stores this metadata in a database. The start-time and end-time may be values within a longer media clip. In that case, the metadata can also include incremental start and end-times, which are distinguished from the actual start time of the media clip within the overall program.

In another embodiment, a single, large database can hold all of the metadata for all of the media clips associated with more than one programming stream. In yet another embodiment, the database is a key value organization, whereby each data object also has an associated key value. In that database may be several types of object. In one embodiment, there is a producer object, which represents data about a program producer or author, a media object, which refers to a video clip or other media item, and a playlist object, which is the play list for a particular programming stream. A unique key value is assigned to each object. Any other object that refers to that key is related. The playlist object uses the keys to refer to the media clip objects. As the playlist queue is processed, the keys are used to locate the media clip objects and fetch the associated media reference codes.

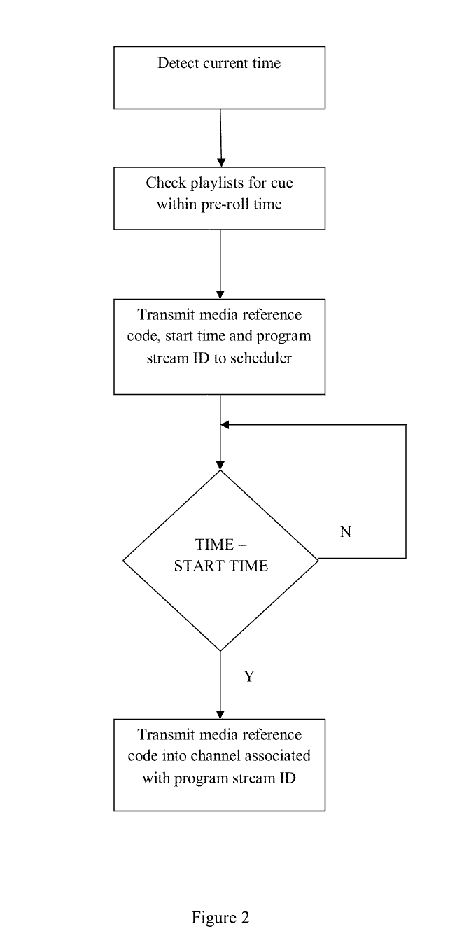

The system maintains a process that continually monitors the database. When a new media clip is added to the database, the process checks the start and end times of the clip in the data record to determine where in the playback queue the media clip belongs. At the same time, the process checks the playback queue against the current run time. As depicted in FIG. 2, when the process detects an upcoming cue for a media clip playback, the process causes a scheduler process to transmit to any user browser that is accessing the scheduler at that time, the code module that references the media clip.

The user's browser is directed toward the scheduler location URL, where a communication channel is opened. The channel can be a protocol between computers referenced by a unique identifier. The channel is designed to operate so that anything input into it is broadcast to all browsers connected to it. In one embodiment it is full-duplex. In another embodiment, the channel is implemented using a websocket. The browser may access the scheduler by means of calling a function from the browser, for example, a player code module. The player that is invoked can then execute a process. The player code can be a code module downloaded from the first website that, built into the code, has a reference to the location of the scheduler. In one embodiment, the player is code called by the iframe construct in the webpage of the first website. In another embodiment, the browser calls a script that downloads an additional script, as follows:

<script
src=“http://staging.stationcreator.com/channels/
4f54fe9c830f781659000006/embed.js”></script>

In this embodiment, the browser will download from the website staging.stationcreator.com a file called embed.js. However, the specific version of the file is located in the directory: channels/4f54fe9c830f781659000006, where the alphanumeric string is the program stream identifier. Each program stream has a unique version of the embed.js file. That is, there is a unique embed.js for each program channel. The reference to the specific embed.js code is the code block inserted into the webpage of the website that will appear to display the program stream. The embed.js file also contains a script, or computer code, that when executed by the browser, opens the websocket connected to the scheduler.

The scheduler begins the transmission of a media clip in the program data stream at the start-time by transmitting through the websocket a media reference code, which is an alphanumeric string that locates the media clip that is to be displayed. In one embodiment, the reference is a URL in combination with an alphanumeric string that uniquely identifies a media clip located at the directory referenced by the URL, which can be a filename. In an alternative embodiment, a reference code may be used in place of a filename and then the server can map the code to the media file to be transmitted. In another embodiment, the reference is transmitted as an embed code. An example of the first example is:

http://www.youtube.com/watch?v=NL91Q-DiL80&feature=g-all-
u&context=G2d12c63FAAAAAAAAAAA/videosource

In the other embodiment, the transmitted media reference code can be:

<iframe width=“560” height=“315”
src=“http://www.youtube.com/embed/NL91Q-DiL80” frameborder=“0”
allowfullscreen></iframe>

At the other end of the websocket connection, the user's browser receives the media reference code. The player module automatically monitors the websocket, essentially waiting for the websocket to deliver the media reference code that the scheduler transmits into the websocket. In yet another embodiment, a mobile device can subscribe to a socket to listen for the embed code metadata when a new video is scheduled. [self subscribeToChannel: @“502c8cc69cd00000e”];

When the media reference code arrives at the user's browser, these need to be rendered by the browser in order for the media playback to commence. Referring now to FIG. 3, the player detects the condition of receipt of the media reference code. Upon that detection, the player causes the web-page of the first website to be re-displayed. That means the browser marches through the code comprising the webpage, with the new reference code inserted into the web page data. In one embodiment, a code module built into the webpage runs this process asynchronously. When this process detects the receipt of the media reference code, it inserts that code module into the webpage itself and then triggers a redisplay of the webpage. As a result, the browser launches the media playback of the media clip referenced by the updated media reference code.

In one embodiment, the embed.js script contains the following code:

```
function setupscheduler( ) {
  var frame = document.-
  getElementById(“video_frame_4f170e2d830f7842f3000002”);
  var scheduler = new scheduler(‘4855ecf7ba2664c81c40’);
  var channel = scheduler.subscribe(“4f170e2d830f7842f3000002”);
```

This last entry opens the websocket to the scheduler. The next block of code script specifies that the item “media” is assigned to the displayed i-frame rendered by the browser.

```
channel.bind(‘new_content’, function(time_block) {
  frame.innerHTML = time_block[“media”];
  window.setTimeout(resetIframe, (time_block[“duration”] + 1) * 1000);
  });
}
```

A timeout trigger is provide so that if there is no response, the browser calls up a default image.

In this block of code, the “media” item is the media reference code received by the websocket. Upon receipt, it causes the next line of code to execute the “resetIframe”, which causes a refresh of the i-frame being rendered by the browser. This causes the launch of the media clip referenced by “media.”

The resetIframe function contains the following code:

```
  function resetIframe( ) {
$.getJSON(“http://staging.stationcreator.com/api/
4f170e2d830f7842f3000002/autopilot.json?call back=?”, function(data) {
  if (data) {
    $(“#video_frame_4f170e2d830f7842f3000002”).html(data[“media”]);
    window.setTimeout(resetIframe, (data[“duration”] + 1) * 1000);
```

The alphanumeric string that is the program stream identifier is present in the references to the locations on the website server as indicated. The function retrieves from a JSON file associated with the program stream the identity of the next media clip and its duration. In this manner, the embed.js script that is unique for each program stream associated with that program's playlist. What is changed in the script file between different program streams is the alphanumeric string that constitutes the program stream ID. This causes the script to call for a different embed.js, which itself opens a different websocket associated with a different playlist generated by the scheduler for that different program stream. In the preferred embodiment, the system calls the resetIframe function recursively.

When the user's browser redisplays the webpage, with the newly inserted media reference code, the browser transmits a request to the URL contained in or referenced by the media reference code as a payload. The reference can be direct or indirect. The actual media data is then transmitted from the servers addressed by the URL to the user's browser. In this embodiment, the audio and video data itself is not stored in the database, nor are the servers housing the database transmitting the media data. In another embodiment, the media reference code can be comprised of a script that instructs the browser in obtaining the URL that hosts the media clip that is being referenced.

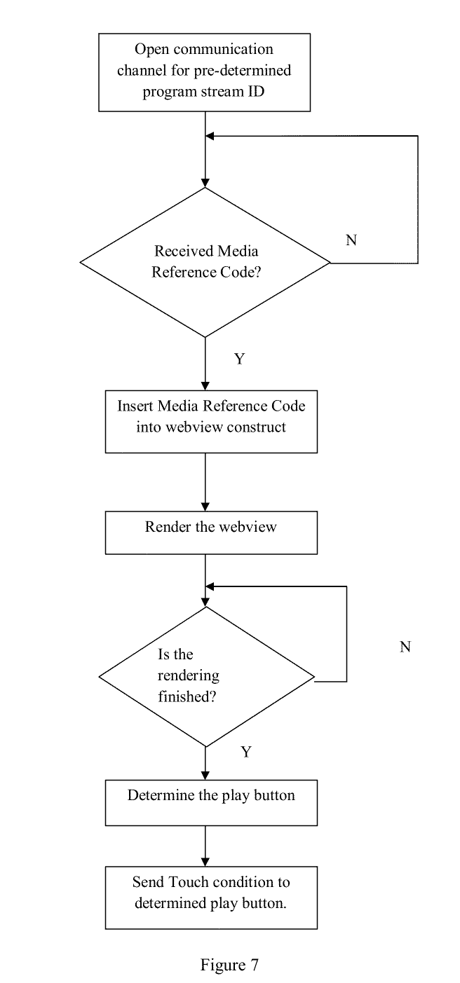

In the mobile embodiment, when reference to a new program stream is received it may be embedded into a webview or similar function for natively displaying the videos. See FIG. 7. A webview is an object oriented programming class that is comprised of methods that will render web-based content on the device user interface screen and other output without reliance on a browser application. As a result of this type of functionality, an application operating on the mobile device can natively display the video without using a browser itself. As described elsewhere, links to video or other program streams, in the form of URL's are pushed to the mobile device. The invention embodied on the mobile device then embeds these URL's as <Insert Video Provider>embeds in a webview so the operating system will natively display it, without a browser being required. The invention also determines which button on the displayed user interface is the “play” or “start” button or the equivalent. As a result, the invention sends a button touch event to the play button instance to cause it to automatically play the video referenced by the embedded URL. Each time a new program stream link is transmitted through the websocket channel and detected, the invention automatically sends the button touch event in order to launch the video. This simulates continuous play of a video channel.

In one embodiment, the operating system may natively display YouTube™ embeds. The iOS™ operating system is an example of one that natively displays YouTube™ embeds. An example of coding this scheme is generally presented below in Objective C:

- (void)subscribeToChannel:(NSString *) channelName
{
[self embedYouTube:url frame:[[UIScreen mainScreen]
applicationFrame]];
}

In this embodiment, the webview invokes the embedYouTube™ method.

The video stream can then be embedded into the webview. In the example of YouTube™, this is accomplished by a method called embedYouTube™ procedure as follows:

- (void) embedYouTube:(NSString*)url frame: (CGRect)frame {
NSString* embedHTML = @“\
<html><head>\
<style type=\“text/css\”>\
body {\
background-color: transparent;\
color: white;\
}\
</style>\
</head><body style=\“margin:0\”>\
<embed id=\“yt\” src=\“%@\” type=\“application/
x-shockwave-flash\”
\
width=\“%0.0f\” height=\“%0.0f\”></embed>\
</body></html>”;
NSString* html =[NSString stringWithFormat:embedHTML, url,
frame.size.width, frame.size.height];
if(webView == nil) {
webView = [[UIWebView alloc]
initWithFrame:frame];
[self.view addSubview:webView];
}
[webView loadHTMLString:html baseURL:nil];
}

In another embodiment, the webview with the embedded video is configured to automatically play each video that arrives over the channel. In one embodiment, the WebView can be configured to play the video as a result of detecting that the webview has finished rendering. In this example embodiment, the code would appear as follows:

- (void)webViewDidFinishLoad:(UIWebView *)_webView
{
UIButton *b = [self findButtonInView:_webView]; [b
sendActionsForControlEvents:UIControlEventTouchUpIn side];
}

To perform the autoplay, the program loops over the DOM elements in the embed as shown below and then submits a Touch event to it, that is a UlButton event as noted above.

- (UIButton *)findButtonInView:(UIView *)view { UIButton
*button = nil;
if ([view isMemberOfClass:[UIButton class]]) {
return (UIButton *)view;
}
if (view.subviews && [view.subviews count] > 0)
{
for (UIView *subview in view.subviews) {
button = [self findButtonInView:subview];
if (button) return button;
}
}
return button;
}

In one embodiment, the database is continually polled to determine if any media clips are due for playback for all of the program stream playlists and to cause the scheduler to transmit the media reference codes at a particular time. The polling process sorts the database in the sequence of start times associated with the media clips. The polling process can then fetch the next start time associated with a media clip. At the same time, the polling process tracks the actual time. The polling process can compare the start time to the actual time. If the two are within a pre-determined pre-roll period, the polling process takes action to cause the scheduler to add the media clip item to the queue of items it is scheduling for that program stream. When the polling process determines that there is an upcoming need for a media clip at a specific upcoming start time, it transmits the media reference code to the Scheduler. The Scheduler function can either be independent from the process of polling the media clip database or it can be integrated into the same component. In the preferred embodiment, the scheduler is a separate process because it operates in real-time: the scheduler has to transmit the media reference code to the browser at the time the clip is to be launched on the viewer's browser.

In one embodiment, the scheduler maintains a separate queue for each program stream. Each program stream is referenced by a key value. In this embodiment, the polling process transmits to the scheduler a data message comprised of the media reference code, start-time and key value for the program stream. Alternatively, the program stream ID may be used. The scheduler stores that data in the next logical location in its data store associated with the program stream referenced by the key value. The scheduler then transmits this information at the specific required start time to all browsers that are calling for the program stream by accessing its associated websocket. An important aspect of the invention is that a given program stream can be comprised of media clips from a variety of sources, not just one source. For example, a program stream can be constructed with a reference to a video clip from one website, followed by a video clip from an entirely different website. Yet on the user's browser, it has the appearance of being one on-going channel of programming.

In one embodiment a message is transmitted to the scheduler that is comprised of: $scheduler->trigger(‘program-stream-id’, ‘start-time’, ‘media reference code’); The poller sends the trigger command to the scheduler. This command tells the scheduler to transmit the media reference code into the websocket associated with program-stream-id at the start-time. The browser executing an embed.js script that has opened a websocket to the same program stream id will then receive that media reference code. In this example, the scheduler receives a command that at the indicated start-time, transmit the media reference code to the identified program stream recipients. When that occurs, the media reference code is transmitted into the websocket connections established between the user's browsers and the scheduler.

As the number of individual program streams increase, this can create a computer processing and communications bottleneck. That is, a single polling process on a single server will eventually reach a limit where it cannot cause the scheduler to transmit the media reference codes on time. Similarly, the scheduler may reach the point that it cannot receive a large volume of entries into its queue or cause simultaneous transmissions of media reference codes into a large number of websockets.

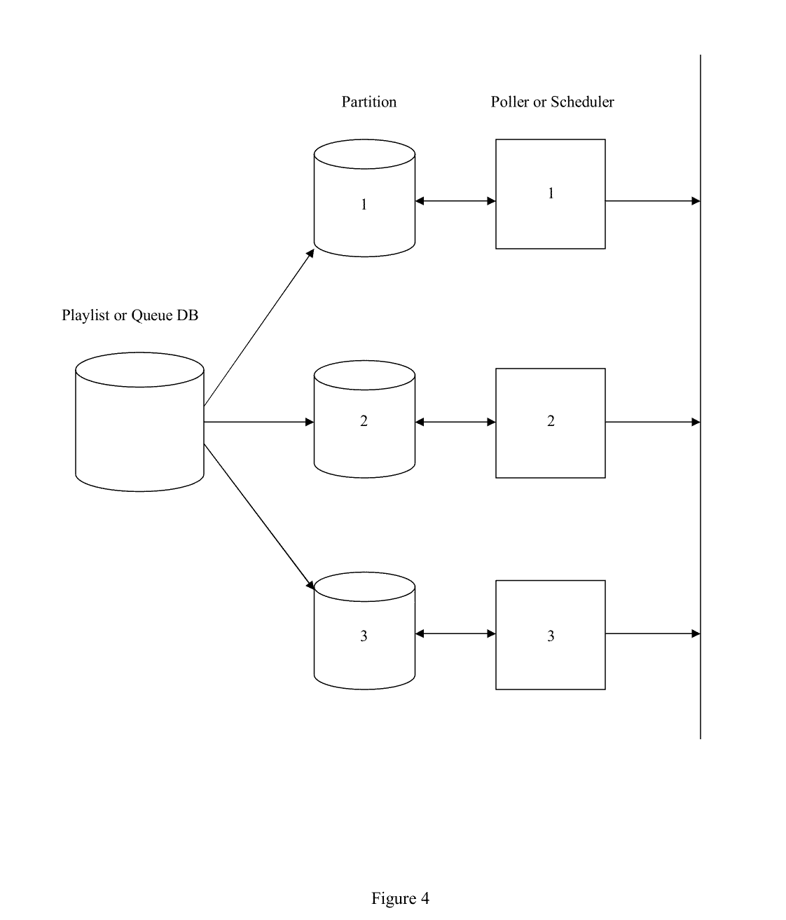

In yet another embodiment, the system is designed so that it can scale to accomplish its task with any number of program streams running at the same time. In this embodiment, there are N number of different polling processes going through the database looking to see if there are any media clips due for transmission. In this embodiment, there is a collision prevention or collision detection scheme to prevent two different polling processes from servicing the same media object that is due for transmission. In one embodiment, each of the N polling processes is assigned a subset of the key values associated with the program playlists, each such subset being disjoint to the other. In this way, each program playlist is serviced by only one polling process. In yet another embodiment, the database can be physically partitioned so that more than one computer server can house the entire database, such that each server has a distinct subset of the database that can be serviced by a polling process without access to the other servers being necessary on an ongoing basis. The partition can similarly be made on the basis of distinct playlist objects. In this embodiment, any object shared among more than one playlist, each in disjoint subsets, is copied into the other partition so that the polling process operating on the first partition does not need to reference the same object residing at the other partition. See FIG. 4. In this manner, the system can operate in a multi-processor environment and scale to any number of program playlist streams. Similarly, the scheduler functionality can be compartmentalized so that there are N schedulers operating, with each of the N scheduling processes operating on a subset of the program streams. The polling processes then address commands to a scheduler based on the mapping the program stream identifier to a scheduler process. This mapping can be encoded in a data file that is updated as scheduling processes are created or destroyed. In this manner, the scheduling process can be optimized to operate in a multiprocessor environment.

In yet another embodiment, the database can be partitioned. However, shared media objects are accessible across the partition boundaries. If this cross-partition access occurs infrequently, then on average, performance of the system resulting from scaling will not be impaired by scaling the system to service large numbers of program playlists. In order to accomplish this, each server that houses a partition will operate a caching system for cross-partition accesses. In this scheme, when a particularly popular media object is called for repeatedly, each partition server will maintain that data in a cache. If the media object is written or updated, then the overall system will flush all of the partition caches.

In some cases, the forced transmission of the media clip is not satisfactory. As a result, an alternative embodiment may be used. In this embodiment, the playlist is transmitted to the player operating in the browser. The player logic can then monitor the current time, and march down the playlist to determine when to fetch the next media clip for display. In this embodiment the player monitors the playlist and at the time the next media clip is to be displayed, the webpage is updated to have a new iframe construct with the next media reference code placed in the iframe instance. Then the webpage is redisplayed to cause the browser to fetch the referenced media clip and display it within the frame. In yet another embodiment, the first website can transmit an upcoming cue to the player, that is, a reference to the media clip and the start time. This may be transmitted earlier than the indicated start time and received and stored by the user's computer. The player then fine-tunes the result, by placing the reference into its queue and transmitting the media reference code at the specific time that the player measures.

The architecture of the system is comprised of several logical components. First, there is the database that houses the media objects and playlist objects. (101) Second, there is a poller engine that monitors the database to determine if any media objects have start-times within an upcoming pre-determined pre-roll amount of time. (102) The poller delivers these to the third component, the scheduler. (103) The scheduler component maintains one or more queues of media reference codes and corresponding start-times. Each queue is associated with a unique program stream, typically a program channel that appears on a website that calls for that specific program stream. The scheduler (103) responds to requests from browsers seeking one of the program streams by opening a communication channel (105) with the browser (104) and then transmitting the current media reference code at the indicated start time (108) into the corresponding channel. If the channel is opened after the start time of a current media clip, then the media reference code is also accompanied by a time offset so that the user's browser can request that the current media clip be launched at a point after its start time. In another embodiment, a new viewer will retrieve starting at the beginning of the current media clip. Upon the next transmission of a media reference through the websocket, the next media clip will start at the appointed time.

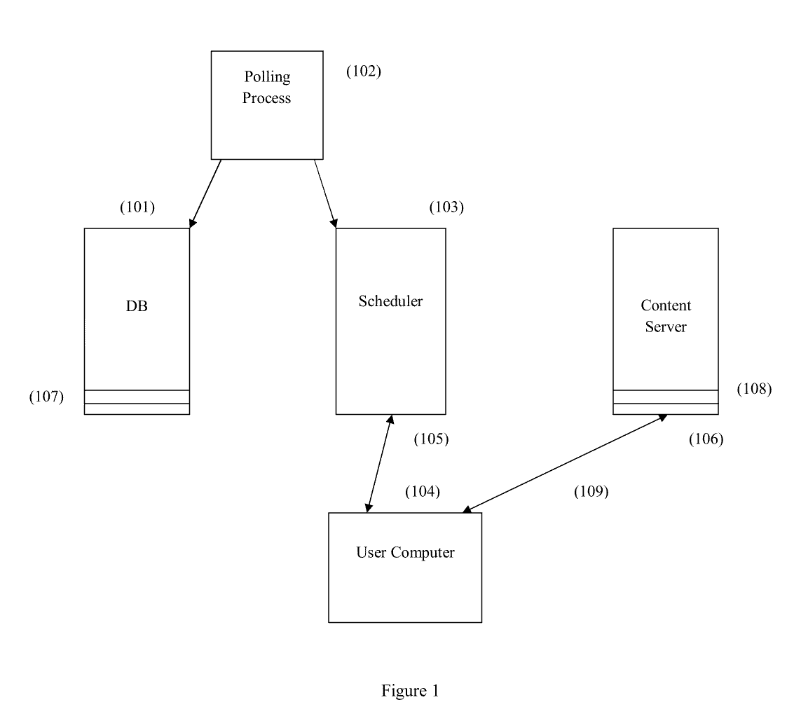

Referring to FIG. 1, the database (101) is monitored by the polling process (102). When an upcoming media object (107) is determined to be due for transmission, the polling process (102) moves it to the scheduler (103). The user's computer (104) has opened a communication channel with the scheduler (105). When the user's computer receives the media reference code, it makes a request (109) using the location referenced by media reference code to the content provider referred to by the location code (106) for the specific media clip referenced by the reference code (108). This content is then transmitted back to the requesting computer (104) and displayed on that computer's output device.

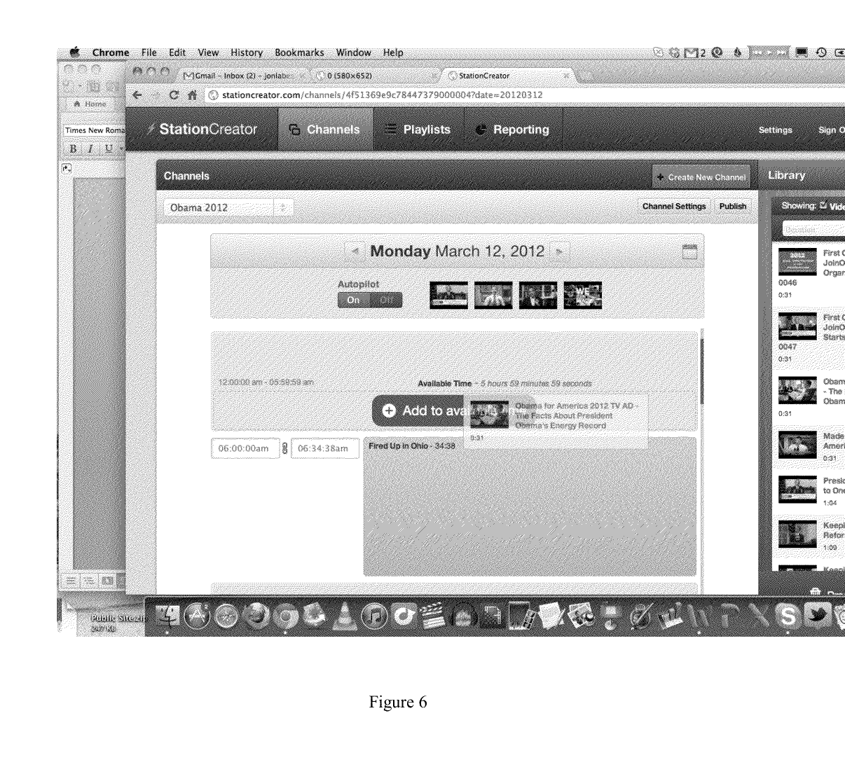

The system is further comprised of a component that permits a program stream author to specify the sequence and timing of media clips to be presented in the program stream. This scheduling tool causes graphical user interface to be presented to the author operating the tool. The scheduling abstraction permits the author to select media clip items from a library list and then place this items graphically in the order to be presented. See FIG. 6. The system determines the duration of a clip that is added and then is able to calculate the actual end-time of the clip and therefore the start time for the next clip. In one embodiment, the system automatically determines where the available time is in the edited program stream specification and adds the selected clip to that location. As media clips are added to the program stream specification, the defined available times automatically shrink. In yet another embodiment, the author can request that the system automatically populate the schedule with the selected media clips. In that embodiment, the system algorithmically determines a best fit of the available times and the selected media clip durations to optimize the schedule for that program stream.

As presented in FIG. 7, the author can use a typical graphical user interface metaphor to select and hold a media clip over an indicated available time, whereby the system prompts the author whether to add that clip to the available time. When the author releases the media clip, the data structure encoding the specification of the program stream is updated with the media clip identifier, start time and duration. The graphical user interface is also updated to present the appearance of that addition to the program stream.

In another embodiment, each media clip is assigned a unique alphanumeric identifier or key. A play list for a program channel is then a list of these keys. Use of the key to map to the media object data structure permits the system to fetch the title, duration and URL of the media clip. In yet another embodiment, the playlist can be a list where each entry contains these items and the start time and duration. The author of the program stream can edit the start point and duration of the media clip and update the playlist entry.

### Operating Environment:

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a firewall proxy to one server, which routes communications to another server that executes the disclosed methods. The precise details of the data network architecture does not limit the claimed invention. Further, the user's computer may be a laptop or desktop type of personal computer. It can also be a video game console, a cell phone, smart phone or other handheld device. The precise form factor of the user's computer does not limit the claimed invention. In one embodiment, the user's computer is omitted, and instead a separate computing functionality provided that works with the central server. In this case, a user would log into the server from another computer and access the program stream. In another embodiment, the user can operate a local computer running a browser, which receives from a central server a program stream comprised of data that is rendered by the browser into a performance of the media clip.

In this embodiment, the user computer captures the input of the user, e.g. audio input, video input and movement of the trackpad or other input device, and transmits data to the server. The Server then transmits a sequence of media reference codes out to users' computers that then immediately begin displaying that content.

Further, the user may receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (JO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space have different URL's.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C++, C#, Action Script, PHP, EcmaScript, JavaScript, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the database management system can be embodied by cloud storage services such as Amazon SimpleDB™, which may be housed in one or more operatively connected servers operatively connected to computer memory, for example, disk drives. The database can be organized as a column-oriented database rather than a relational database, such as SQL™. The invention may be executed on another computer that is presenting a user a symbolic representation of available data. That second computer can execute the invention by communicating with the set of servers that house the database management system. In yet another embodiment, the initialization of the database management system may be prepared on the set of servers and the interaction with the user's computer occur at a different place in the overall process.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

The term “mobile computing device,” as used herein, may be a laptop, a netbook, a personal digital assistant (PDA), a smart phone (e.g., a Blackberry™., an Iphone™ etc.), a portable media player (e.g., an IPod Touch™), or any other device having communication capability to connect to the network. In one example, the mobile computing device connects to the network using one or more cellular transceivers or base station antennas (not shown in FIG. 1), access points, terminal adapters, routers or modems (in IP-based telecommunications implementations), or combinations of the foregoing (in converged network embodiments).

In some instances, the network is the Internet. In some instances, the network is a local network maintained by a private entity or a wide area public network, or a combination of any of the above types of networks. In some instances, especially where a mobile computing device is used to access web content through the network (e.g., when a 3G or an LTE service of the phone is used to connect to the network), the network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

What is claimed:

1. A method of displaying a program stream on a computing device comprising:
Transmitting from a transmitting system to the computing device a media reference code corresponding to the program stream in order to cause the computing device, upon receiving the media reference code, to perform a method comprising the steps of:
modifying a webview construct with data obtained using the transmitted media reference code;
rendering the webview construct ;
determining if the rendering is complete;
determining a button that when provided a touch condition causes a video player operating on the user's computing device to start; and
invoking a touch condition to the determined button in order to cause the program stream referenced by the transmitted media reference code to be rendered by the video player.

2. The method of claim 1 where the transmitting step is further comprised of transmitting the media reference code through a websocket channel between the transmitting system and the computing device.

3. The method of claim 1 where the determined button is a component of the webview construct.

4. A method executed by a user's computer for displaying a program stream associated with a media reference code comprising:
Receiving a media reference code corresponding to the program stream;
Modifying a webview construct with data obtained using the media reference code;
Rendering the webview construct;
Determining if the rendering is complete;
In dependence on the determination step, establishing a touch condition on a button that causes a video player to start in order to cause the program stream referenced by the media reference code to be rendered by the video player.

5. The method of claim 4 further comprising:
Determining a button that when provided a touch condition causes a video player operating on the user's computing device to start.

6. The method of claim 5 where the determined button is part of the webview construct.

7. The method of claim 4 further comprising:
Establishing a websocket channel with a remote server computer that transmits the media reference code; and
Entering a state of monitoring the websocket channel in order to determine when a media reference code has arrived from the remote server through the websocket channel.

8. A computer readable data storage device containing digital data that, when loaded into a computer and executed as a program, causes the computer to execute any of the methods of claims 1 through 7.

9. A computer system adapted to execute any of the methods of claims 1 through 7.
